(19) United States
(12) Patent Application Publication
(10) Pub. No.: US 2025/0285799 A1
(43) Pub. Date: Sep. 11, 2025

(54) COIL COMPONENT

(71) Applicant: Murata Manufacturing Co., Ltd., Kyoto-fu (JP)

(72) Inventors: Mutsumi YOKOHAMA, Nagaokakyo-shi (JP); Kenji HASHIMOTO, Nagaokakyo-shi (JP)

(73) Assignee: Murata Manufacturing Co., Ltd., Kyoto-fu (JP)

(21) Appl. No.: 19/070,833

(22) Filed: Mar. 5, 2025

(30) Foreign Application Priority Data
Mar. 6, 2024 (JP) 2024-033764

(51) Int. Cl. H01F 27/28

(52) U.S. Cl. CPC H01F 27/2823

(57) ABSTRACT

In a coil component in which a terminal electrode including a conductor film including a sintered body of a conductive paste is provided on a mounting surface of a core facing a mounting board side, a fixing strength of the terminal electrode is increased. Mounting surfaces include raised portions having tops inside end edges of the mounting surfaces in a width direction orthogonal to the axial direction of the winding core, and the raised portions form inclined surfaces extending downward from the tops toward the end edges. When the conductive paste to be conductor films is applied to the mounting surfaces, since the raised portions are on the mounting surfaces, an applied thickness of the conductive paste can be increased, and the conductor films including a sintered body of the conductive paste can be formed thick, thus increasing the fixing strength of terminal electrodes to the mounting surfaces.

### CROSS-REFERENCE TO RELATED APPLICATION

This application claims benefit of priority to Japanese Patent Application No. 2024-033764, filed Mar. 6, 2024, the entire content of which is incorporated herein by reference.

### BACKGROUND

### Technical Field

The present disclosure relates to a coil component including a core having a winding core around which a wire is wound and flanges provided at ends in an axial direction of the winding core, and a terminal electrode provided at the flange and to which the wire is connected, and particularly relates to a structure of a portion of the flange where the terminal electrode is provided.

### Background Art

For example, Japanese Patent Application Laid-Open No. 2017-041589 discloses a coil component including a core having a winding core around which a wire is wound and flanges provided at ends of the winding core. A terminal electrode is provided on a mounting surface of the flange facing a mounting board side at the time of mounting. A wire is connected to the terminal electrode by thermocompression bonding. The terminal electrode includes a conductor film including a sintered body of a conductive paste applied to the mounting surface.

### SUMMARY

The conductive paste to be the conductor film included in the terminal electrode is applied to the mounting surface by, for example, a dipping method. In the coil component described in Japanese Patent Application Laid-Open No. 2017-041589, as shown in the drawings of Japanese Patent Application Laid-Open No. 2017-041589, the mounting surface on which the terminal electrode is provided is flat. When the mounting surface is flat as described above, a thickness of the conductive paste applied thereto may not be sufficiently secured. In this case, there is a problem that a fixing strength of the terminal electrode to the mounting surface is lowered.

Therefore, the present disclosure provides a coil component capable of increasing the fixing strength of the terminal electrode to the mounting surface.

The present disclosure is directed to a coil component including a core having a winding core extending in an axial direction and flanges provided at ends in the axial direction of the winding core; a wire wound around the winding core; and a terminal electrode to which the wire is connected.

The flange has a mounting surface facing a mounting board side at the time of mounting. The terminal electrode includes a conductor film including a sintered body of a conductive paste applied to the mounting surface.

Also, the present disclosure is characterized in that the mounting surface is provided with a raised portion having a top located inside an end edge of the mounting surface in a width direction orthogonal to the axial direction, and the raised portion forms an inclined surface extending downward from the top toward the end edge.

According to the present disclosure, when the conductive paste to be the conductor film included in the terminal electrode is applied to the mounting surface by, for example, the dipping method, the raised portion is provided on the mounting surface, so that an applied thickness of the conductive paste can be increased. Therefore, the conductor film including the sintered body of the conductive paste can be formed thick, and the fixing strength to the mounting surface of the terminal electrode including the conductor film can be increased.

### BRIEF DESCRIPTION OF THE DRAWINGS

FIG. 1 is a bottom view showing an appearance of a coil component 1 according to an embodiment of the present disclosure from a mounting surface side;

FIG. 2A is a sectional view taken along line A-A in FIG. 1, and FIG. 2B is a sectional view taken along line B-B in FIG. 1; and

FIG. 3 is a sectional view for explaining a step of thermocompression bonding a wire 32 to a terminal electrode.

### DETAILED DESCRIPTION

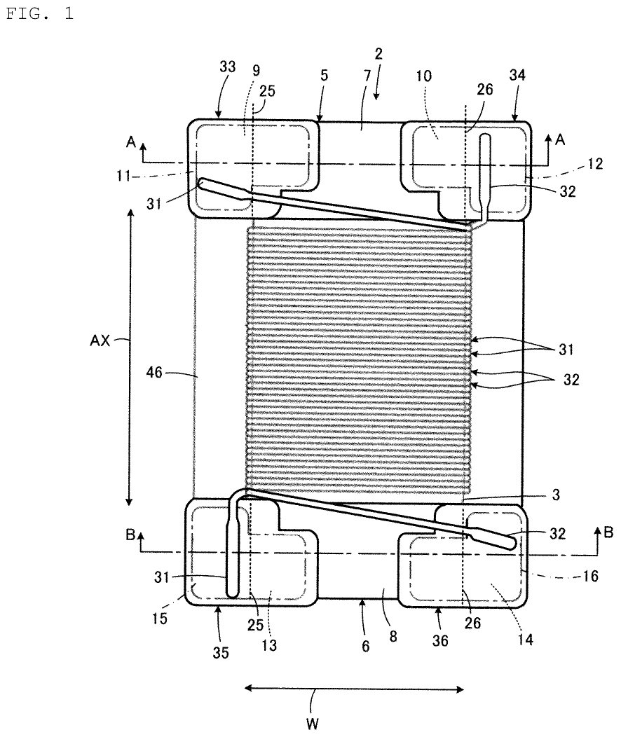

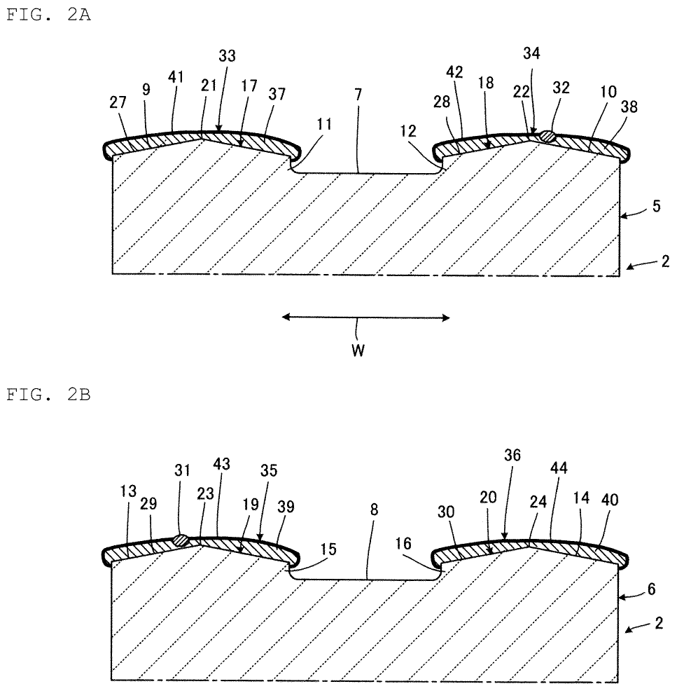

A coil component 1 according to an embodiment of the present disclosure will be described with reference to FIGS. 1, 2A, and 2B.

The coil component 1 constitutes, for example, a common mode choke coil, and includes a core 2 including, for example, ferrite such as Ni—Zn-based ferrite, alumina, or resin containing metal magnetic powder. As shown in FIG. 1, the core 2 includes a winding core 3 extending in an axial direction AX, and a first flange 5 and a second flange 6 respectively provided at first and second ends opposite to each other in the axial direction AX of the winding core 3. The shown winding core 3 has, for example, a quadrangular cross-sectional shape, but may have a polygonal shape such as a hexagonal shape, a circular shape, an elliptical shape, or a shape obtained by combining these shapes.

Bottom surfaces 7 and 8 of the first flange 5 and the second flange 6 facing a mounting board (not shown) side at the time of mounting appear in FIG. 1.

On the bottom surface 7 of the first flange 5, two mounting surfaces 9 and 10 facing the mounting board side are arranged side by side in a width direction W orthogonal to the axial direction AX. As well shown in FIGS. 2A and 2B, the mounting surface 9 is located at a protrusion 11 raised from the bottom surface 7 with a step. The other mounting surface 10 is located at a protrusion 12 raised from the bottom surface 7 with a step.

Similarly, on the bottom surface 8 of the second flange 6, two mounting surfaces 13 and 14 facing the mounting board side are arranged side by side in the width direction W. The mounting surface 13 is located at a protrusion 15 raised from the bottom surface 8 with a step. The other mounting surface 14 is located at a protrusion 16 raised from the bottom surface 8 with a step.

By respectively positioning the mounting surfaces 9, 10, 13, and 14 on the protrusions 11, 12, 15, and 16, a step of applying a conductive paste described later can be easily performed by a dipping method.

As well shown in FIG. 2A, the mounting surface 9 is provided with a raised portion 17 that rises, and the mounting surface 10 is provided with a raised portion 18 that rises. Further, as well shown in FIG. 2B, the mounting surface 13 is provided with a raised portion 19 that rises, and the mounting surface 14 is provided with a raised portion 20 that rises. The raised portions 17, 18, 19, and 20 respectively have tops 21, 22, 23, and 24.

As shown in FIG. 1, the tops 21 and 23 are located on a virtual broken line 25, and the tops 22 and 24 are located on a virtual broken line 26. That is, the top 21 of the raised portion 17 is located inside an end edge of the mounting surface 9 in the width direction W, the top 22 of the raised portion 18 is located inside an end edge of the mounting surface 10 in the width direction W, the top 21 of the raised portion 19 is located inside an end edge of the mounting surface 13 in the width direction W, and the top 24 of the raised portion 20 is located inside an end edge of the mounting surface 14 in the width direction W.

The top 21 of the raised portion 17 has a portion extending linearly along the virtual broken line 25, that is, a portion extending linearly in parallel with the axial direction AX of the winding core 3. The top 22 of the raised portion 18 has a portion extending linearly along the virtual broken line 26, that is, a portion extending linearly in parallel with the axial direction AX of the winding core 3. The top 23 of the raised portion 19 has a portion extending linearly along the virtual broken line 25, that is, a portion extending linearly in parallel with the axial direction AX of the winding core 3. The top 24 of the raised portion 20 has a portion extending linearly along the virtual broken line 26, that is, a portion extending linearly in parallel with the axial direction AX of the winding core 3.

As shown in FIG. 2A, the raised portion 17 forms an inclined surface 27 extending downward from the top 21 toward the end edge of the mounting surface 9, and the raised portion 18 forms an inclined surface 28 extending downward from the top 22 toward the end edge of the mounting surface 10. Similarly, as shown in FIG. 2B, the raised portion 19 forms an inclined surface 29 extending downward from the top 23 toward the end edge of the mounting surface 13, and the raised portion 20 forms an inclined surface 30 extending downward from the top 24 toward the end edge of the mounting surface 14.

The inclined surface 27 of the raised portion 17 has a gradient viewed in a section (not shown) parallel to the axial direction AX of the winding core 3 larger than that viewed in a section (appears in FIG. 2A) perpendicular to the axial direction AX of the winding core 3. Similarly, the inclined surface 28 of the raised portion 18 has a gradient viewed in a section parallel to the axial direction AX of the winding core 3 larger than that viewed in a section perpendicular to the axial direction AX of the winding core 3, the inclined surface 29 of the raised portion 19 has a gradient viewed in a section parallel to the axial direction AX of the winding core 3 larger than that viewed in a section perpendicular to the axial direction AX of the winding core 3, and the inclined surface 30 of the raised portion 20 has a gradient viewed in a section parallel to the axial direction AX of the winding core 3 larger than that viewed in a section perpendicular to the axial direction AX of the winding core 3.

In addition to the core 2 described in detail above, the coil component 1 includes a first wire 31 and a second wire 32 wound around the winding core 3, a first terminal electrode 33 and a third terminal electrode 35 to which ends of the first wire 31 are respectively connected, and a second terminal electrode 34 and a fourth terminal electrode 36 to which ends of the second wire 32 are respectively connected. As shown in FIGS. 2A and 2B, the terminal electrodes 33 to 36 respectively include conductor films 37 to 40 including a sintered body of a conductive paste applied to each of the mounting surfaces 9, 10, 13, and 14.

In order to form the conductor films 37 to 40, for example, a step of applying the conductive paste by the dipping method is performed. As the conductive paste, for example, a paste containing glass and silver is used. As described above, since the mounting surfaces 9, 10, 13, and 14 are located at the protrusions 11, 12, 15, and 16, the conductive paste can be easily applied to the mounting surfaces 9, 10, 13, and 14 by the dipping method.

The conductor films 37 to 40 obtained by firing the conductive paste applied as described above can be made relatively thick due to the presence of the raised portions 17 to 20 as shown in FIGS. 2A and 2B. Thus, fixing strengths of the terminal electrodes 33 to 36 to the mounting surfaces 9, 10, 13, and 14 can be increased. In this embodiment, the conductor films 37 to 40 are thicker at portions located around the tops 21 to 24 of the raised portions 17 to 20 than at portions located on tops 21 to 24 of the raised portions 17 to 20. This is particularly effective in increasing resistance of the terminal electrodes 33 to 36 to an external force in the width direction W.

Plating films 41 to 44 including, for example, a nickel plating layer and a tin plating layer on the nickel plating layer is formed on the conductor films 37 to 40 as necessary. In FIGS. 2A and 2B, the plating films 41 to 44 are schematically shown by thick lines.

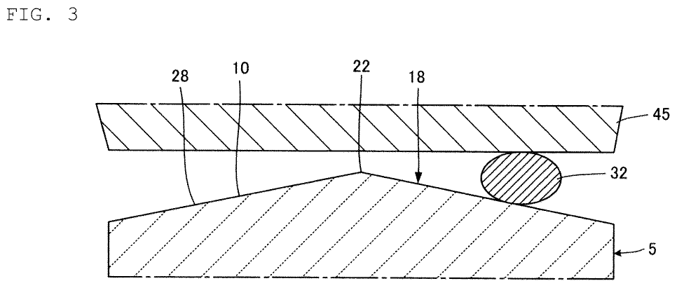

FIG. 3 is a view for explaining a thermocompression bonding step for connecting the wires 31 and 32 to the terminal electrodes 33 to 36. FIG. 3 shows the mounting surface 10 as a representative of the mounting surfaces 9, 10, 13, and 14 on which the terminal electrodes 33 to 36 are provided, and shows the second wire 32. Since the thermocompression bonding step is performed substantially similarly for any of the terminal electrodes 33 to 36, the thermocompression bonding step for the terminal electrode 34 provided on the mounting surface 10 will be described with reference to FIG. 3. Note that in FIG. 3, the conductor film 38 provided on the mounting surface 10 and the terminal electrode 34 including the conductor film 38 are not shown.

In the thermocompression bonding step, a heater chip 45 for thermocompression bonding is operated toward the mounting surface 10 with the wire 32 sandwiched between the heater chip 45 and the mounting surface 10. Thus, the wire 32 is thermocompression bonded to the terminal electrode 34 (not shown in FIG. 3).

At this time, it is preferable that the wire 32 is disposed at a position other than the top 22 on the inclined surface 28 of the raised portion 18, and is connected to the terminal electrode 34 at this position. This is because when the wire 32 is located to overlap the top 22, stress concentrates on a portion of the wire 32 in contact with the top 22, and the wire 32 may be cut at the portion where the stress concentrates.

The wire 32 is preferably connected to the terminal electrode 34 at a portion providing a height difference equal to or less than a diameter of the wire 32 before connection in the inclined surface 28. With this configuration, a sufficient load can be applied from the heater chip 45 to the wire 32 at the time of pressure bonding, and pressure bonding quality can be stabilized. The diameter of the wire 32 is that “before connection” because the wire 32 after connection is flat, and the diameter of the wire 32 varies before and after connection.

Note that in an implemented product, for example, it is assumed that the diameter of the wire 32 before connection is 10 μm or more and 50 μm or less (i.e., from 10 μm to 50 μm), and the height difference of the inclined surface 28 is 1 μm or more and 10 μm or less (i.e., from 1 μm to 10 μm).

As illustrated in FIG. 1, the coil component 1 may further include a top plate 46. The top plate 46 includes, for example, substantially the same material as a material constituting the core 2, and is stretched between surfaces respectively opposite to the bottom surfaces 7 and 8 of the first flange 5 and the second flange 6 to be fixed to the core 2.

In this embodiment, for example, the inclined surface 28 extends from the top 22 of the raised portion 18 in at least two directions opposite to each other in the width direction W. The same applies to the inclined surfaces 27, 29, and 30. When the inclined surfaces 27 to 30 are formed in this manner, a preferable pressure bonding portion of the wires 31 and 32 with respect to the terminal electrodes 33 to 36 can be more widely provided as compared with a case where the inclined surface extends only in one direction.

Although the present disclosure has been described with reference to the shown embodiment, various other modifications can be made within the scope of the present disclosure.

For example, the coil component according to the present disclosure may be a coil component constituting a transformer, a balun, or the like, or may be a coil component constituting a single coil, in addition to a coil component constituting the common mode choke coil as in the shown embodiment. Accordingly, the number of wires can also be changed depending on a function of the coil component, and the number of terminal electrodes provided on each flange can also be changed accordingly.

In the shown embodiment, the tops 21 to 24 of the raised portions 17 to 20 provided on the mounting surfaces 9, 10, 13, and 14 have linearly extending portions, and the linearly extending portions extend parallel to the axial direction AX of the winding core 3, however, the linearly extending portions may extend in a direction not parallel to the axial direction AX, for example, in a direction orthogonal to the axial direction AX.

The raised portion may not have a linearly extending portion, and may be provided to rise in a shape such as a conical shape or a truncated conical shape on the mounting surface.

Further, in the shown embodiment, on the mounting surfaces 9, 10, 13, and 14, the tops 21 to 24 of the raised portions 17 to 20 are at the highest position, but the highest portion may be present at a place other than the top.

In the shown embodiment, the raised portions 17 to 20 have a triangular section, and the tops 21 to 24 are located at tops of triangles, however, the top of the triangle providing the top may be chamfered, or a sectional shape of the entire raised portion may be a partial circle, a partial ellipse, or a shape similar thereto.

In configuring the coil component according to the present disclosure, partial replacement or combination of configurations can be made between different embodiments described in this specification.

The present disclosure includes the following embodiments.

<1> A coil component including a core having a winding core extending in an axial direction and flanges provided at ends in the axial direction of the winding core; a wire wound around the winding core; and a terminal electrode to which the wire is connected. The flange has a mounting surface facing a mounting board side at the time of mounting. The terminal electrode includes a conductor film provided on the mounting surface. Also, the mounting surface is provided with a raised portion having a top located inside an end edge of the mounting surface in a width direction orthogonal to the axial direction, and the raised portion has an inclined surface extending downward from the top toward the end edge.

<2> The coil component according to claim <1>, in which the mounting surface is located at a protrusion raised with a step from a bottom surface of the flange facing the mounting board side at the time of mounting.

<3> The coil component according to <1> or <2>, in which the conductor film has a portion located around the top of the raised portion thicker than a portion located on the top of the raised portion.

<4> The coil component according to any one of <1> to <3>, in which the top of the raised portion has a linearly extending portion.

<5> The coil component according to <4>, in which the linearly extending portion extends parallel to the axial direction of the winding core.

<6> The coil component according to <5>, in which the inclined surface extends from the top in at least two directions opposite to each other in the width direction.

<7> The coil component according to <4>, in which the linearly extending portion extends in a direction orthogonal to the axial direction of the winding core.

<8> The coil component according to any one of <1> to <7>, in which the inclined surface of the raised portion has a gradient viewed in a section parallel to the axial direction of the winding core larger than a gradient viewed in a section perpendicular to the axial direction of the winding core.

<9> The coil component according to any one of <1> to <8>, in which the wire is connected to the terminal electrode at a position other than the top in the inclined surface.

<10> The coil component according to any one of <1> to <9>, in which the wire is connected to the terminal electrode at a portion providing a height difference equal to or less than a diameter of the wire before connection in the inclined surface.

<11> The coil component according to <10>, in which the diameter of the wire before connection is 10 μm or more and 50 μm or less (i.e., from 10 μm to 50 μm), and the height difference of the inclined surface is 1 μm or more and 10 μm or less (i.e., from 1 μm to 10 μm).

What is claimed is:

1. A coil component comprising:
a core having a winding core extending in an axial direction and flanges at ends in the axial direction of the winding core;
a wire wound around the winding core; and
a terminal electrode to which the wire is connected, wherein
the flange has a mounting surface facing a mounting board side at the time of mounting,
the terminal electrode includes a conductor film on the mounting surface, and
the mounting surface includes a raised portion having a top inside an end edge of the mounting surface in a width direction orthogonal to the axial direction, and the raised portion has an inclined surface extending downward from the top toward the end edge.

2. The coil component according to claim 1, wherein
the mounting surface is at a protrusion raised with a step from a bottom surface of the flange facing the mounting board side at the time of mounting.

3. The coil component according to claim 1, wherein
a thickness of a portion of the conductor film around the top of the raised portion is thicker than a thickness of a portion of the conductor film on the top of the raised portion.

4. The coil component according to claim 1, wherein
the top of the raised portion has a linearly extending portion.

5. The coil component according to claim 4, wherein
the linearly extending portion extends in a direction parallel to the axial direction of the winding core.

6. The coil component according to claim 5, wherein
the inclined surface extends from the top in at least two directions opposite to each other in the width direction.

7. The coil component according to claim 4, wherein
the linearly extending portion extends in a direction orthogonal to the axial direction of the winding core.

8. The coil component according to claim 1, wherein
a gradient of the inclined surface of the raised portion viewed in a cross section parallel to the axial direction of the winding core is larger than a gradient of the inclined surface of the raised portion viewed in a cross section perpendicular to the axial direction of the winding core.

9. The coil component according to claim 1, wherein
the wire is connected to the terminal electrode at a position other than the top in the inclined surface.

10. The coil component according to claim 1, wherein
the wire is connected to the terminal electrode at a portion of the inclined surface having a height difference equal to or less than a diameter of the wire before connecting the wire.

11. The coil component according to claim 10, wherein
the diameter of the wire before connecting the wire is from 10 μm to 50, and
the height difference of the inclined surface is from 1 μm to 10 μm.
